(19) United States
(12) Patent Application Publication
(10) Pub. No.: US 2018/0343396 A1
(43) Pub. Date: Nov. 29, 2018

(54) REFLECTIVE TRUNCATED BALL IMAGING SYSTEM

(71) Applicant: SPECTRUM OPTIX, INC., Calgary (CA)

(72) Inventors: John Daugela, Calgary (CA); Darcy Daugela, Calgary (CA)

(21) Appl. No.: 15/989,888

(22) Filed: May 25, 2018

Related U.S. Application Data
(60) Provisional application No. 62/511,724, filed on May 26, 2017.

(51) Int. Cl. H04N 5/232; G02B 13/00; G02B 15/15; G01S 17/89; G01S 7/481; G03B 13/08; G02B 23/00

(52) U.S. Cl. CPC H04N 5/23296; G02B 13/009; G02B 13/0015; G02B 23/145; G01S 17/89; G01S 7/481; G03B 13/08; G02B 15/15

(57) ABSTRACT

A reflective truncated ball imaging system includes: a reflective truncated ball element having a first surface, a second surface and a third surface for reflecting incident light beams from an object having a width of X entering into the first surface, from the second surface towards the third surface to exit the third surface and form an image of the object with a width Y; a focusing lens for focusing the reflected light beams exiting the third surface; and a sensor or view finder for sensing or viewing the light beams focused by the focusing lens.

### CROSS-REFERENCE TO RELATED APPLICATIONS

This patent application claims the benefits of U.S. Provisional Patent Application Ser. No. 62/511,724, filed on May 26, 2017 and entitled “Reflective Truncated Ball Long Range Imaging System,” the entire content of which is hereby expressly incorporated by reference.

### FIELD OF THE INVENTION

The disclosed invention generally relates to imaging systems and more particularly to a reflective truncated ball imaging system.

### BACKGROUND

There is a desire for long range imaging devices to be smaller and lighter. High quality long range imaging devices typically require a large and heavy optical lens system. These lens systems are large and heavy because they require a large aperture and focal length in order to provide sufficient resolution and minimize aberrations. For example, the size and weight constraints of mobile, compact, or weight constrained imaging devices can limit resolution because they constrain the maximum aperture.

Also, there is a desire for all lens systems to be easy to assemble and align, however, this is particularly a challenge in very small lens systems, like cameras in mobile devices.

### SUMMARY OF THE INVENTION

In some embodiments, the disclosed invention is a versatile compact imaging system including a reflective truncated ball lens, and optionally a freeform telescopic lens. In some embodiments, the imaging system of the disclosed invention may be embodies in one monolithic form factor to produce high quality images in a compact space. In some embodiments, the disclosed invention is capable of fitting a large aperture lens system with an improved resolution, in a compact space.

In some embodiments, the disclosed invention is a reflective truncated ball imaging system that includes: a reflective truncated ball element having a first surface, a second surface and a third surface for reflecting incident light beams from an object having a width of X entering into the first surface, from the second surface towards the third surface to exit the third surface and form an image of the object with a width Y; a focusing lens for focusing the reflected light beams exiting the third surface; and a sensor or view finder for sensing or viewing the light beams focused by the focusing lens.

In some embodiments, the focusing lens may be movable to magnify the image of the object. In some embodiments, the reflective truncated ball element is cylindrical to provide a high resolution and large field of view in one axis, and a lower resolution and lower field of view in an axis orthogonal to said one axis.

In some embodiments, the reflective truncated ball element is moveable to change an angle of view to a plurality of objects and may be used in a light detection and ranging (LIDAR) system. In some embodiments, the imaging system further includes a free form optical element positioned between the reflective truncated ball element and the focusing lens for increasing a focal point of the reflective truncated ball imaging system.

In some embodiments, the imaging system further includes a second reflective truncated ball element; a second focusing lens for focusing the reflected light beams exiting the reflective truncated ball element; a second sensor or view finder for sensing or viewing the light beams focused by the second focusing lens; a third reflective truncated ball element; a third focusing lens for focusing the reflected light beams exiting the reflective truncated ball element; a third sensor or view finder for sensing or viewing the light beams focused by the third focusing lens, arranged in a linear array, a grid array, or circular configuration.

When X is smaller than Y the image of the object is expanded and when X is larger than Y the image of the object is compressed.

### BRIEF DESCRIPTION OF THE DRAWINGS

A more complete appreciation of the disclosed invention, and many of the attendant features and aspects thereof, will become more readily apparent as the disclosed invention becomes better understood by reference to the following detailed description when considered in conjunction with the accompanying drawings in which like reference symbols indicate like components.

FIG. 1 shows an exemplary configuration of a reflective truncated ball lens system, according to some embodiments of the disclosed invention.

FIG. 2 shows an exemplary configuration of a reflective truncated ball lens with a freeform telescope lens system, according to some embodiments of the disclosed invention.

FIG. 3 depicts an exemplary configuration of a scanning reflective truncated ball lens system, according to some embodiments of the disclosed invention.

FIGS. 4A and 4B show some configurations for multiple reflective truncated ball lens systems, according to some embodiments of the disclosed invention.

FIG. 5 illustrates a dual reflective truncated ball lens system, according to some embodiments of the disclosed invention.

FIG. 6 depicts a reflective truncated ball lens systems used in a microscopic configuration, according to some embodiments of the disclosed invention.

FIG. 7 shows a reflective truncated ball lens system with mechanism/structures for alignment of lens, according to some embodiments of the disclosed invention.

FIG. 8 shows a freeform telescopic element, according to some embodiments of the disclosed invention.

FIG. 9 shows some embodiments of a reflective truncated ball lens system with several sensor elements, according to some embodiments of the disclosed invention.

FIG. 10 illustrates an ad hoc-shaped reflective truncated ball lens system, according to some embodiments of the disclose invention.

FIGS. 11A and 11B illustrate a scanning reflective truncated cylindrical lens system, according to some embodiments of the disclose invention.

### DETAILED DESCRIPTION

In some embodiments, the disclosed invention is a monolithic lens system, which is easier to assemble and align, and is robust to thermal and vacuum extremes. The disclosed invention can be used to produce a monolithic lens system where the lenses can physically align to each other and thus reduce or eliminate the need for complex alignment methods and fixtures.

The following terms used in this disclosure include these definitions:
Light refers to any electromagnetic (EM) wave energy visible or outside of visible spectrum.
The term optical element refers to a physical item that interacts with light. An element is typically made out of one material, in contrast to a monolithic lens which may be made of different elements each with different materials.
A ball element is a curved element where light enters and exits through the same physical surface. An example of a ball element with a uniform curvature is a sphere. A ball element may or may not have a uniform curvature about a central point. It may have different curvatures on the input and output surface as the optical design dictates.
A truncated ball element is a ball element that is cut to form an optically active surface. Light still enters and exits through the same physical surface. An example of a truncated ball element with uniform curvature is a hemisphere. The optically active surface may be planar, or may have power, or may be a freeform surface.
A reflective truncated ball element is a truncated ball element, where the optically active surface is reflective. An example of a reflective surface may be a surface with a mirror coating, or the surface is reflecting the light by total internal reflection.
The term lens is intended to be one or more optical elements that together perform an optical function.
A lens system is defined as an optical system that receives light from a field of view and arranges the light on one or more sensors and contains one or more lenses and one or more optical elements.
A sensor may be an electronic light or EM wave sensor, or an animal or human eye. The electronic sensor may also be a light field sensor that is an array of micro-lens over a plurality of pixels on an image sensor. For example, the light field sensor may be made up of a grid of 300 micro-lens, and each micro-lens may be placed on top of a grid of 16 pixels. The sensor may also be curved to match the optical surface that it is aligned with to reduce aberrations.
A monolithic lens is a lens wherein the optical elements physically touch each other and may optionally be bonded together. Monolithic lens systems can be easier to align, because the spacing between the elements is zero. Monolithic lens systems can also have very good temperature stability which is advantageous for extreme operating environments, like space.

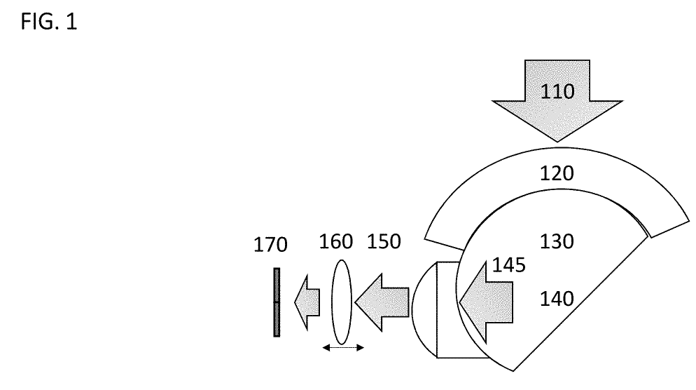

FIG. 1 shows an exemplary configuration of a reflective truncated ball lens system 100, according to some embodiments of the disclosed invention. As shown, light from an image 110 passes through an optional (focusing) lens 120, before entering a reflective truncated ball element 130. The light is reflected off the back by a reflective surface 140, such as a mirror, or by total internal reflection. The reflected light 145 exits the reflective truncated ball element and passes through an optional exit lens 150, before entering an optical focusing and/or zoom lens 160 that is moveable to focus and/or magnify the image. The light then forms an image on one or more sensor(s) or view finders 170.

When the light enters the reflective truncated ball element 130, the lens system 100 has a positive power. When the light exits the reflective truncated ball element, the lens system 100 has a negative power. A positive powered lens converges light towards the optical axis, while a negative powered lens diverges light away from the optical axis. The combination of a positive powered lens system, followed by a negative powered lens system tends to concentrate the light. The combination is afocal with the light concentrated. This concentration helps to reduce the size of subsequent elements, making the device (lens system) more compact. Also, by changing the direction of the optical axis through the reflection at surface 140, the depth of the optics can be minimized to fit in available size constraints. The optional exit lens 150 can also be used to correct aberrations and distortions of the image. The optical elements do not need to be concentric about the truncated ball element center point. However, if they are not concentric, they would form a well-defined optical axis, which facilitates alignment. The light path through the reflective truncated ball element 130 can be reversed to provide uniform illumination.

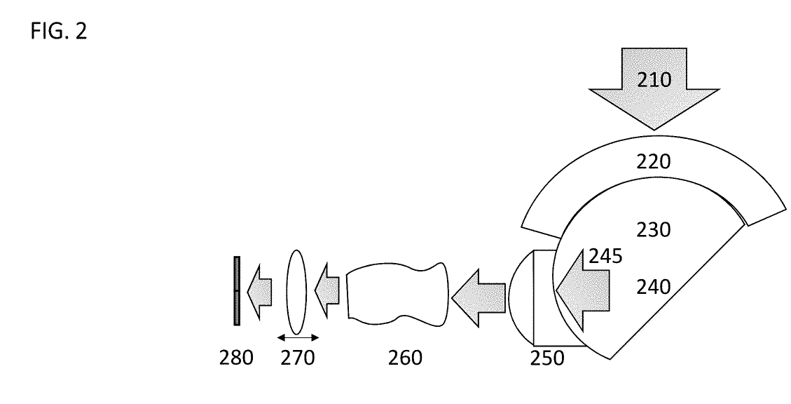

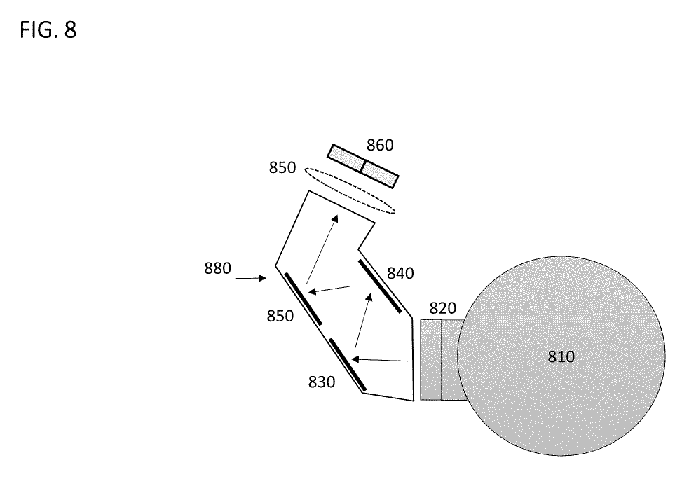

FIG. 2 shows an exemplary configuration of a reflective truncated ball lens with a freeform telescope lens system, according to some embodiments of the disclosed invention. As shown, light from an image 210 passes through an optional (focusing) lens 220, before entering a reflective truncated ball element 230. The light is reflected off the back surface 240 (by a reflective surface, or by total internal reflection). The reflected light 245 exits the reflective truncated ball element 230, passes through an optional exit lens 250, and enters a freeform element 260 (for example, a freeform telescope, as described with respect to FIG. 8) with multiple freeform surfaces. The freeform element 260 corrects any residual aberrations, and increases the focal length of the system (to increase magnification). The light exits the freeform element 260, and passes through an optional focusing lens and/or zoom lens 270 to form an image on one or more image sensor(s) 280. The freeform element 260 allows the focal length of the system to be increased in a very compact space. This increased focal length allows for greater magnification of the image, which can be desirable for imaging objects further from the lens. In some embodiments, all or part of the lens system from elements 220 to 280 form a monolithic lens system. The light path through the reflective truncated ball element 230 can be reversed to provide uniform illumination.

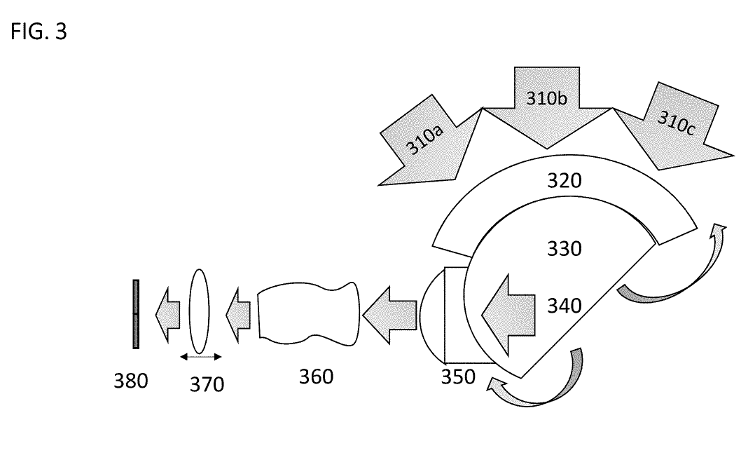

FIG. 3 shows an exemplary configuration of a compact scanning lens system, according to some embodiments of the disclosed invention. A reflective truncated ball element 330 and optionally, first lens 320 are rotatable and/or moveable to change the angle of view to a plurality of the images 310a, 310b and 310c that reach one or more image sensor(s) 380. In some embodiments, the reflective truncated ball element 330 remains stationary and the reflective surface 340 is rotated and/or moved. This method can be used to collect data from a wider field. A possible use is to assemble multiple images together into a simulated wider panoramic view. Another example of use is to find or identify light such as a laser, for example in a light detection and ranging (LIDAR) system. The scan can be in multiple directions (horizontal and vertical) to increase the field of view. All the other elements (350, 360, 370 and 380) operate similar to those depicted in FIG. 1. The light path through the (movable) reflective truncated ball element 330 can be reversed to provide illumination.

In some embodiments, the orientation and/or distance of the reflective truncated ball element 330 and optionally, first lens 320 may be varied or adjusted, for example, by turning a knob or by a servo motor controlled manually or automatically by a software program, based on the application of the dual reflective truncated ball lens system.

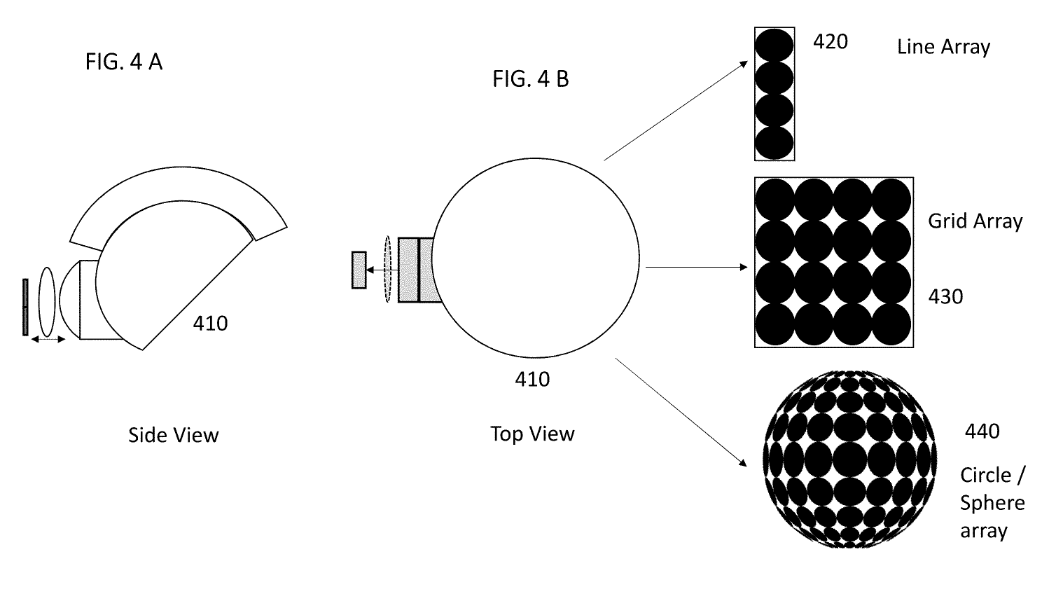

FIGS. 4A and 4B show some configurations for multiple reflective truncated ball lens systems, according to some embodiments of the disclosed invention. FIG. 4A is a side view and FIG. 4B is a top view. As depicted, several of reflective truncated ball lens systems 410, similar to the reflective truncated ball system shown in one or more of FIGS. 1-3, can be arranged in different configurations, such as a line pattern 420, grid array pattern 430, or in a sphere pattern 440 to increase the field of view of capture the same or different information from the same or different field of view. A line array may be useful for push-broom type scanning, such as on a satellite or aircraft. A grid and spherical array may be useful for generating a very high resolution consolidated image with a very high wide field of view. One skilled in the art would recognize that any combination of reflective truncated ball lens systems according to FIGS. 1-3 may be used in these embodiments of multiple reflective truncated ball lens systems.

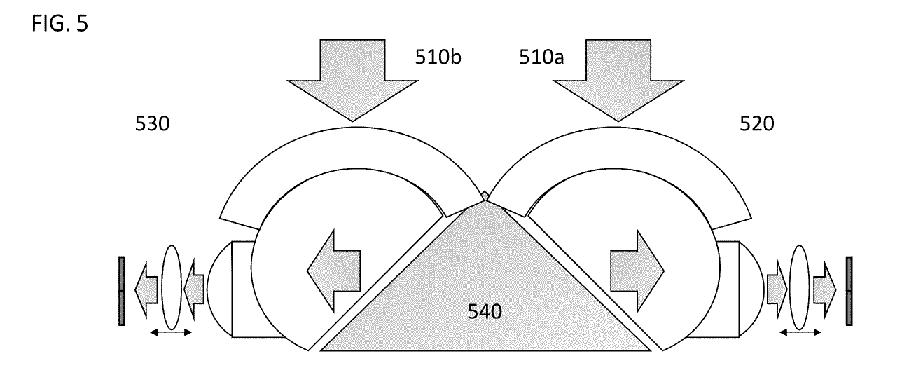

FIG. 5 shows an exemplary configurations of a dual reflective truncated ball lens system, according to some embodiments of the disclosed invention. As shown, two reflective truncated ball lens systems 520 and 530 (each including elements similar to those illustrated in one or more of FIGS. 1-3) can fit together on one support structure 540 to facilitate alignment of the device. This configuration produces two images. One skilled in the art would recognize that a variety of different forms and shapes may be designed to hold the dual lens system at different orientations and distances from each other. In some embodiments, the orientation and/or distance of the support structure 540 may be varied or adjusted, for example, by turning a knob or by a servo motor controlled manually or automated by a software program, based on the application of the dual reflective truncated ball lens system. A dual lens system can be suitable for a variety of applications including allowing stereoscopic 3D vision, viewing a wider light spectrum, viewing a wider field of view, and/or used for binoculars. The light path of one or both lens systems can be reversed to provide illumination. One skilled in the art would recognize that any combination of reflective truncated ball lens systems according to FIGS. 1-3 may be used in these embodiments of multiple reflective truncated ball lens systems. In other words, one or both of the two reflective truncated ball lens systems 520 and 530 may have any of the configurations depicted in FIGS. 1-3 and described in the corresponding paragraphs.

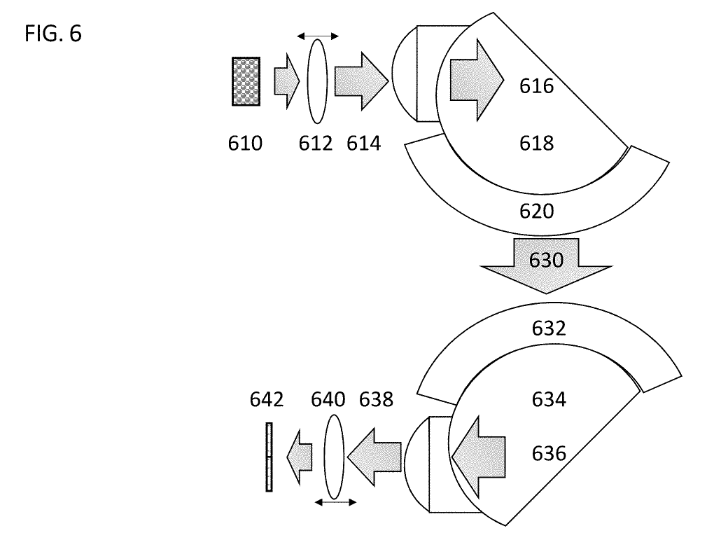

FIG. 6 shows an exemplary configuration of a microscope system, according to some embodiments of the disclosed invention. The light from a sample to be viewed 610 passes through an adjustable objective lens 620. In some embodiments, the powered lens is adjustable by being moved, as typically done in microscopes. The light passes to an optional correcting lens 630, before entering the first ball lens 650 elements. The light is then reflected off a reflective surface 640, and exits the first ball 650 element and an optional lens 660 (to add more negative power if required). The light 670 then passes into an optional lens 680, and a second ball lens 690 before reflecting off the back surface 700 and exiting through an optional correcting lens 710, before passing through an optional zoom or focusing lens 720, and forming an image on a sensor(s) 730. This configuration provides a highly magnified high quality image of the sample for a microscope, and can be created by replicating two similar lens system and thus simplifying and harmonizing the manufacturing of a compact microscope.

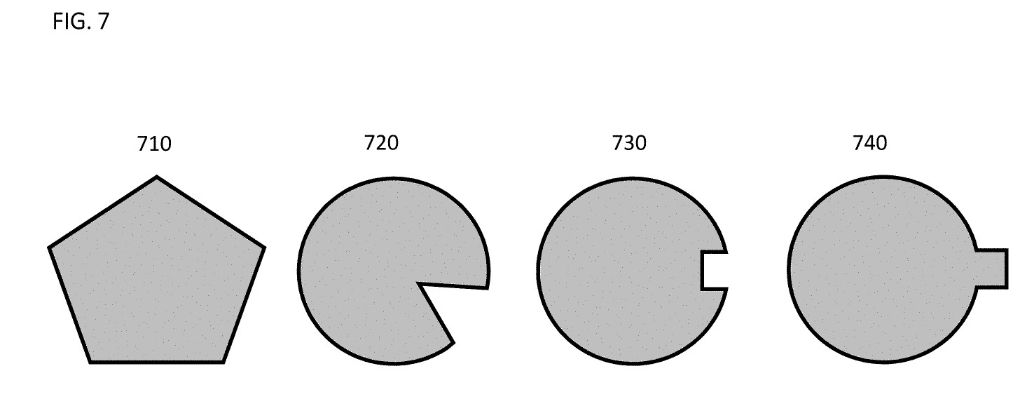

FIG. 7 shows a ball lens system with mechanisms and/or structures for alignment of lens, according to some embodiments of the disclosed invention. FIG. 7 shows some exemplary configurations for creating means to align the ball element in any of the embodiments depicted in FIGS. 1-6 and 8-11. One skilled in the art would recognize that if the ball elements are not properly aligned on the optical axis, then the image will have aberrations and/or distortions. Because these elements are small and uniform, a substantially perfect alignment may be difficult. Accordingly, FIG. 7 illustrates different options that could be used to align these truncated ball elements. The ball lenses would be aligned to fit into a support structure. Since the ball element may not be uniform, it would be difficult to align it without a mechanism or structure for such alignment. A person skilled in the art would recognize that there are many alternatives to modify the ball lens so that it is not spherical but still can be easily aligned. For example, a mark, cut, protrusion, vertex, or nob of many different shapes and sizes can be used to align the ball element, truncated ball element, or reflective truncated ball element. For instance, a polygon 710 with any number of sides, a circle with a wedge-shape cut 720, a circle with a rectangular or square-shaped cut 730, or a circle with a rectangular or square-shaped protrusion may be used to align the ball element. These structures/shapes on the ball lens element would fit precisely and only in one correct orientation into the structure that keeps the lens system, or align sufficiently for the lens to be secured (e.g., by glue) in place.

FIG. 8 shows a possible configuration of a freeform telescopic element, according to some embodiments of the disclosed invention. A shown, the light enters from the truncated reflective ball lens 810, and passes through an optional exit lens 820 and enters a freeform telescope 880. The light is then reflected from multiple reflective surfaces 830, 840, and 850, before it exits the lens. In some embodiment, the telescope is a compact monolithic focal telescope, meaning that the elements would be contacting each other and secured, for example, by glue. It is also possible the telescope is made from one solid material. One or more of these reflective surfaces are designed to correct aberrations or distortions of the final image. Although, three reflective surfaces are depicted in these exemplary embodiments, other number of reflective surfaces are possible and within the scope of the disclosed invention. A NASA publication, “Freeform Optical Design of Two Mirror Telescopes,” Joseph Howard, Garrett West, NASA, GSFC, Optics Branch, Code 551, the entire contents of which is hereby expressly incorporated by reference, describes a freeform two mirror telescope in more detail.

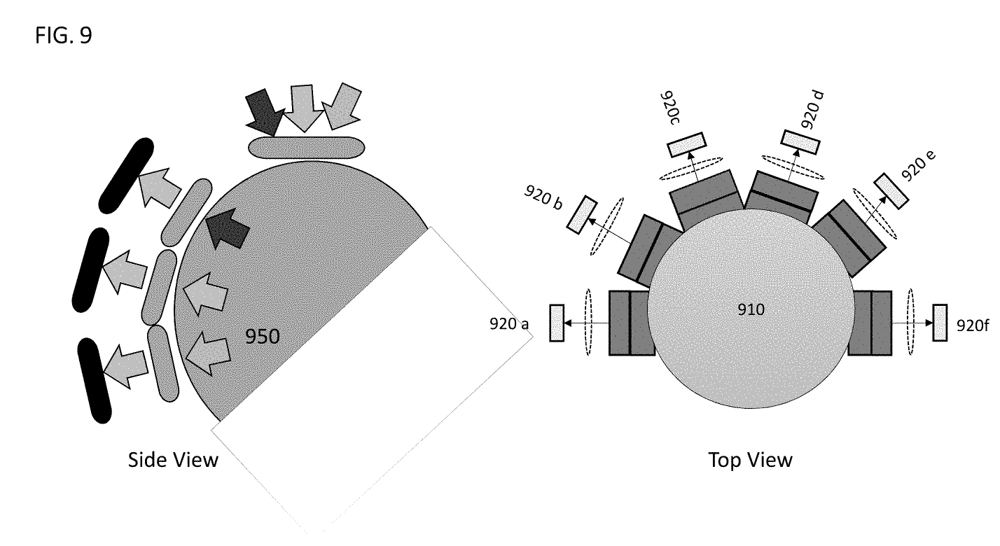

FIG. 9 shows some embodiments of a reflective truncated ball lens system with many sensor(s) elements. In some embodiments, the light enters a truncated ball lens 910 from the top (into the page), and is reflected out to many sensor/camera systems, as shown in 920a, 920b, 920c, 920d, 920e, and 920f. The reflective surface in the ball lens system may not be flat in order to distribute light to each lens. In some embodiments, the light enters a ball lens 950 from the top, and is reflected off one surface to multiple sensors. In this case, the reflecting surface may be planar. The sensors/cameras can be arranged around the balls 910 and/or 950 to provide the desired field of view, not just in one line, but in multiple lines. It is not necessary for each camera system to use a relay lens or form an intermediate image. One skilled in the art would recognize that any combination of reflective truncated ball lens systems according to FIGS. 1-3 may be used in these embodiments of multiple reflective truncated ball lens systems.

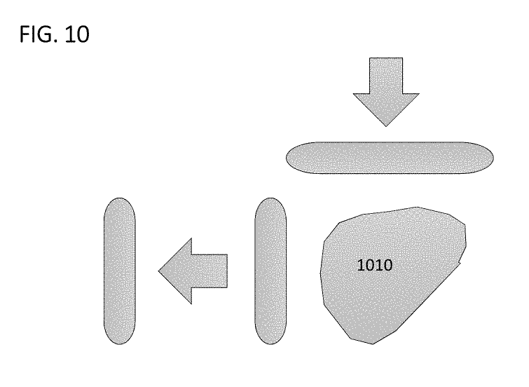

FIG. 10 illustrates an ad hoc-shaped reflective truncated ball lens system, according to some embodiments of the disclose invention. All the depicted optical elements are similar to those shown in FIG. 1 and/or FIG. 2, except that the truncated ball lens 1010 has an ad hoc shape, for example, an irregular curved-shape.

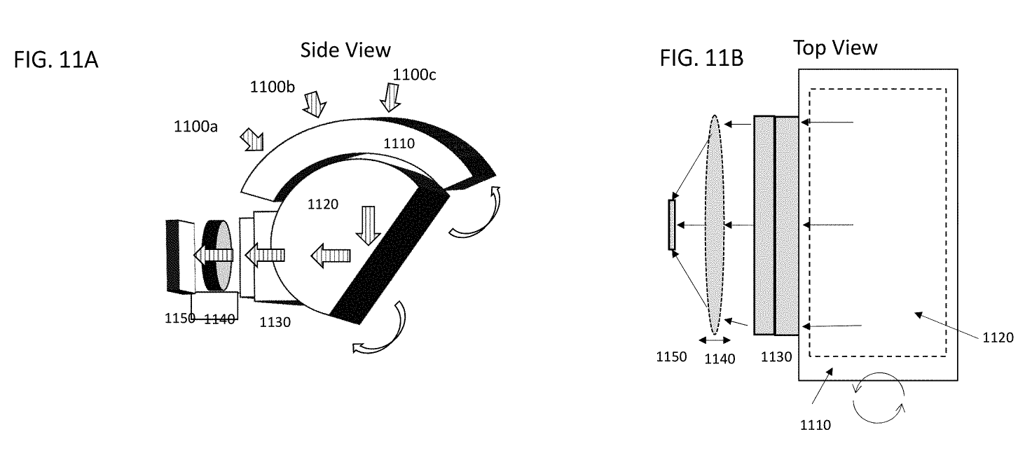

FIGS. 11A and 11B illustrate a scanning reflective truncated cylindrical lens system, according to some embodiments of the disclose invention. FIG. 11A is a side view and FIG. 11 B is a top view. In some embodiments, this lens system is well suited to long range line scanning. As shown, light from the field of view 1100 enters optional element 1110 before reaching the reflective truncated cylindrical element 1120, and reflecting off the surface and exiting to optional element 430 before being focused and/or magnified by lens 1140 onto a sensor 1150. As the reflective truncated cylindrical element 1120 rotates, light from different fields (1100a, 1100b, and 1100c) reach the sensor 1150. The data collected from each of the different fields can be assembled together to form a composite field. The light path and components are similar to FIG. 3, except the elements are cylindrical. The reflective truncated cylindrical element 1120 may be rotated automatically and controllably, for example, by a computer program driving a servo motor, manually, or by other means known in the art.

This cylindrical configuration permits the lens system to have a high resolution and large field of view in one axis, and a lower resolution, and lower field of view in the orthogonal axis. This configuration of the lens is well suited to line scanning over a large field quickly. An example of use would be to improve the speed and simplicity of LIDARs by reading a full line instead of several points one at a time. The large aperture and narrow field of view would improve the sensor signal to noise ratio, and permit a lower powered laser to detect objects further away. The laser light projection can be directly coupled to the rotating mechanism on the lens to simplify alignment of the laser light with the lens field of view. An alternative use is to use the scanning reflective truncated cylindrical lens system to quickly and efficiently assemble an image from a wide field of view with high resolution.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope of the invention as defined by the appended claims and drawings.

1. A reflective truncated ball imaging system comprising:
a reflective truncated ball element having a first surface, a second surface and a third surface for reflecting incident light beams from an object having a width of X entering into the first surface, from the second surface towards the third surface to exit the third surface and form an image of the object with a width Y;
a focusing lens for focusing the reflected light beams exiting the third surface; and
a sensor or view finder for sensing or viewing the light beams focused by the focusing lens.

2. The reflective truncated ball imaging system of claim 1, wherein X is smaller than Y to expand the image of the object.

3. The reflective truncated ball imaging system of claim 1, wherein X is larger than Y to compress the image of the object.

4. The reflective truncated ball imaging system of claim 1, further comprising a second focusing lens positioned on the first surface to focus the image of the object onto the first surface.

5. The reflective truncated ball imaging system of claim 1, wherein the incident light beams are reflected from the second surface by a mirror or internal reflection.

6. The reflective truncated ball imaging system of claim 1, wherein the focusing lens is movable to magnify the image of the object.

7. The reflective truncated ball imaging system of claim 6, wherein the reflective truncated ball element is cylindrical to provide a high resolution and large field of view in one axis, and a lower resolution and lower field of view in an axis orthogonal to said one axis.

8. The reflective truncated ball imaging system of claim 1, further comprising a free form optical element positioned between the reflective truncated ball element and the focusing lens for increasing a focal point of the reflective truncated ball imaging system.

9. The reflective truncated ball imaging system of claim 1, wherein the reflective truncated ball element is moveable to change an angle of view to a plurality of objects.

10. The reflective truncated ball imaging system of claim 9, used in a light detection and ranging (LIDAR) system.

11. The reflective truncated ball imaging system of claim 1, further comprising: a second reflective truncated ball element; a second focusing lens for focusing the reflected light beams exiting the reflective truncated ball element; a second sensor or view finder for sensing or viewing the light beams focused by the second focusing lens; a third reflective truncated ball element; a third focusing lens for focusing the reflected light beams exiting the reflective truncated ball element; a third sensor or view finder for sensing or viewing the light beams focused by the third focusing lens, arranged in a linear array, a grid array, or circular configuration.

12. The reflective truncated ball imaging system of claim 1, further comprising a second reflective truncated ball imaging system for producing a second view of a second object or the object; and a support structure for supporting the reflective truncated ball imaging system and the second reflective truncated ball imaging system, providing stereoscopic 3D vision, a wider light spectrum viewing, a wider field of view viewing, or viewing by a binoculars.

13. The reflective truncated ball imaging system of claim 12, wherein the reflective truncated ball imaging system is a positive powered lens system and the second reflective truncated ball imaging system is a negative powered lens system to concentrate the light beams.

14. The reflective truncated ball imaging system of claim 1, wherein the reflective truncated ball element has a spherical, adhoc, cylindrical or curved shape.

15. The reflective truncated ball imaging system of claim 1, further comprising a plurality of sensors for sensing the light beams focused by the focusing lens.
